(19) United States
(12) Patent Application Publication
(10) Pub. No.: US 2013/0032250 A1
(43) Pub. Date: Feb. 7, 2013

(54) GAS CUTTING METHOD, GAS CUTTING MACHINE, AND CUTTING TIP

(71) Applicants: Toyoyuki Sato, Tokyo (JP); Yasuyuki Yamamoto, Tokyo (JP); Takashi Kato, Tokyo (JP); Masayuki Nagahori, Saitama (JP); Hirotaka Kamikihara, Saitama (JP); Takashi Takeda, Saitama (JP)

(72) Inventors: Toyoyuki Sato, Tokyo (JP); Yasuyuki Yamamoto, Tokyo (JP); Takashi Kato, Tokyo (JP); Masayuki Nagahori, Saitama (JP); Hirotaka Kamikihara, Saitama (JP); Takashi Takeda, Saitama (JP)

(73) Assignee: TAIYO NIPPON SANSO CORPORATION, TOKYO (JP)

(21) Appl. No.: 13/641,943

(22) PCT Filed: Mar. 24, 2011
(86) PCT No.: PCT/JP2011/057206

§ 371 Date: Oct. 18, 2012

(30) Foreign Application Priority Data
Apr. 20, 2010 (JP) 2010-097258

(51) Int. Cl. B23K 7/00; B23K 7/06

(52) U.S. Cl. 148/194; 266/48

(57) ABSTRACT

A gas cutting method is provided which includes: mixing hydrogen gas and hydrocarbon gas to acquire fuel gas; ejecting a preheating flame, which is formed by mixing and igniting the fuel gas and preheating oxygen gas, from an end of a cutting tip to heat a workpiece; and ejecting cutting hydrogen gas to the heated workpiece to cut the workpiece. Here, the content of the hydrocarbon gas in the fuel gas is more than 0 vol % and equal to or less than 4 vol %.

### TECHNICAL FIELD

The present invention relates to improvements of a gas cutting method, a gas cutting machine, and a cutting tip.

Priority is claimed on Japanese Patent Application No. 2010-097258, filed Apr. 20, 2010, the content of which is incorporated herein by reference.

### BACKGROUND ART

When a workpiece such as a steel plate is cut, a gas cutting method of cutting the workpiece by heating a cutting start point of the workpiece to a temperature at which an oxidation reaction is possible by the use of a preheating flame and ejecting high-purity oxygen gas to the heated part to combust and melt the heated part has been widely used.

To form a preheating flame in the gas cutting method, hydrocarbon gas (such as LPG, LNG, town gas, acetylene, propane, methane, ethylene, propylene, butane, or mixed gas thereof) as fuel gas and preheating oxygen gas for efficiently combusting the fuel gas have been typically used at a preheating hole.

Recently, fuel gas containing hydrogen gas as a major component instead of hydrocarbon gas has been used to form a preheating flame. Examples of the gas cutting method using the fuel gas containing hydrogen gas as a major component are disclosed in Patent Document 1 or Patent Document 2.

Patent Document 1 discloses a gas cutting method of mixing hydrocarbon gas into mixed gas (oxyhydrogen gas) of oxygen and hydrogen so as to be less than a concentration of a lower explosion limit. Specifically, in order to achieve a concentration less than the lower explosion limit of oxyhydrogen gas, it is disclosed that it is necessary to set the proportion of the hydrocarbon gas in the fuel gas to be equal to or higher than 30%.

Patent Document 2 discloses a gas cutting method using a heat source in which LP gas is added to mixed gas (oxyhydrogen gas) of oxygen and hydrogen in the flow ratio range of LP gas to oxyhydrogen gas of 25:1 to 35:1.

Specifically, in a gas cutting machine 101 shown in FIG. 9, oxyhydrogen gas generated by an oxyhydrogen gas generator 103 is supplied to a pipeline L101, LP gas is supplied to a pipeline L103 from an LP gas bomb 104, both gases are mixed at the junction A of the pipeline L101 and the pipeline L103 to fall within the above-mentioned range, and the resultant is then supplied to a cutting blowpipe 102. Then, a preheating flame is generated from a cutting tip 106 disposed at an end of the cutting blowpipe 102.

### CITATION LIST

### Prior Art Literature

[Patent Document 1] JP-A-2007-000902

[Patent Document 2] Japanese Patent No. 3563660

### DISCLOSURE OF INVENTION

### Problems to be Solved by the Invention

However, in the gas cutting methods disclosed in Patent Document 1 and Patent Document 2, it has been seen that cutting performance such as a cutting speed becomes lower as the concentration of hydrocarbon gas to be mixed into hydrogen gas becomes higher, and theproportion of hydrocarbon gas or LP gas to be mixed needs to be lowered to satisfactorily achieve the cutting performance of hydrogen gas.

On the other hand, when 100% hydrogen into which hydrocarbon gas or LP gas is not mixed at all is used as fuel gas, a flame core of the cutting tip is not visible and thus there is a problem in that it is not possible to adjust the preheating flame.

The use of mixed gas of oxygen and hydrogen which is an explosive gas causes a problem in that there is an explosion hazard for the entire pipeline (for example, the entire pipeline L101 shown in FIG. 9) of oxyhydrogen gas when a mixing problem occurs due to a decrease in pressure of hydrocarbon gas or defects of the machine.

The invention is made to solve the above-mentioned problems. A goal of the invention is to provide a gas cutting method which is safe and superior in cutting performance and which allows a preheating flame to be easily adjusted, a gas cutting machine and a cutting tip used in the gas cutting method.

### Means for Solving the Problems

To achieve the above-mentioned goal, the invention provides the following configuration.

(1) A gas cutting method including: mixing hydrogen gas and hydrocarbon gas to acquire fuel gas; ejecting a preheating flame, which is formed by mixing and igniting the fuel gas and preheating oxygen gas, from an end of a cutting tip to heat a workpiece; and ejecting cutting hydrogen gas to the heated workpiece to cut the workpiece, wherein the content of the hydrocarbon gas in the fuel gas is more than 0 vol % and equal to or less than 4 vol %.

(2) The gas cutting method according to (1), wherein the hydrocarbon gas is propane and the content of propane in the fuel gas is equal to or more than 0.4 vol % and equal to or less than 4 vol %.

(3) The gas cutting method according to claim 1) or (2), wherein the hydrocarbon gas is methane and the content of methane in the fuel gas is equal to or more than 3 vol % and equal to or less than 4 vol %.

(4) The gas cutting method according to any one of (1) to (3), wherein the hydrocarbon gas is butane and the content of butane in the fuel gas is equal to or more than 0.2 vol % and equal to or less than 4 vol %.

(5) The gas cutting method according to any one of (1) to (4), wherein the fuel gas and the preheating oxygen gas are mixed inside a cutting blowpipe, inside the cutting tip, or at an end of the cutting tip.

(6) The gas cutting method according to any one of (1) to (5), wherein when the preheating flame is ejected from an end of the cutting tip to the workpiece, the preheating flame is tilted toward the center in the axis direction of the cutting tip.

(7) The gas cutting method according to any one of (1) to (6), wherein at least one of the hydrogen gas and the preheating oxygen gas are supplied from a water-splitting apparatus from which hydrogen and oxygen can be extracted and which can set an oxygen component in the hydrogen gas and a hydrogen component in the preheating oxygen gas to be less than a lower explosion limit.

The definition that hydrogen and oxygen can be extracted means that the oxygen gas concentration in the hydrogen gas and the hydrogen gas concentration in the oxygen gas are each less than the lower explosion limit.

(8) A gas cutting machine including: a mixer that mixes hydrogen gas and hydrocarbon gas to acquire fuel gas; a cutting tip that includes a preheating hole used to form a preheating flame using the fuel gas and preheating oxygen gas and a cutting oxygen hole used to eject cutting oxygen gas to cut a workpiece; a cutting blowpipe that has the cutting tip disposed at an end thereof; a fuel gas pipeline that supplies the fuel gas to the cutting blowpipe or the cutting tip; a preheating oxygen gas pipeline that supplies the preheating oxygen gas to the cutting blowpipe or the cutting tip; a hydrogen gas supply source that supplies the hydrogen gas to the mixer; a hydrocarbon gas supply source that supplies the hydrocarbon gas to the pipeline; and an oxygen gas supply source that supplies the preheating oxygen gas to the preheating oxygen gas pipeline, wherein the content of the hydrocarbon gas in the fuel gas is more than 0 vol % and equal to or less than 4 vol %, and the fuel gas pipeline and the preheating oxygen gas pipeline join inside the cutting blowpipe, inside the cutting tip, or outside the cutting tip.

(9) A cutting tip of a gas cutting machine, including: a cutting oxygen gas flow channel that passes through the center in the axis direction of the cutting tip; a preheating gas flow channel that is formed by joining a fuel gas flow channel and a preheating oxygen gas flow channel and that is disposed outside the cutting oxygen gas flow channel; a cutting oxygen hole that is disposed at an end of the cutting oxygen gas flow channel; and a preheating hole that is disposed at an end of the preheating gas flow channel, wherein the end of the preheating gas flow channel is tilted to an extension of the cutting oxygen gas flow channel.

(10) The cutting tip according to (9), wherein the distance from a junction of an extension from an end of the preheating gas flow channel and an extension of the cutting oxygen gas flow channel to the end of the cutting tip is in the range of 10 to 20 mm.

### Effects of the Invention

According to the gas cutting method and the gas cutting machine of the invention, since hydrogen gas and oxygen gas which are major components of fuel gas are not mixed before reaching the cutting blowpipe or the cutting tip, it is possible to greatly reduce the explosion hazard in the fuel gas pipeline, thereby enhancing the safety.

Since the proportion of hydrocarbon gas mixed into hydrogen gas which is a major component of fuel gas is set to a low range of a proportion more than 0 vol % (the lowest proportion at which a flame core is visible) and equal to or less than 4 vol % (the highest proportion at which the cutting speed can be maintained), it is possible to guarantee the original cutting performance of hydrogen gas and to allow the flame core to be recognized, thereby allowing the preheating flame to be easily adjusted.

It is possible to perform concentrated preheating by combining the cutting tip in which the end of the preheating gas flow channel is inclined to the center of the cutting tip. Accordingly, it is possible to suppress a backfire caused because the preheating gas flow channel of the cutting tip is clogged with the blowup of molten metal which often occurs mainly in piercing (boring) processes, thereby reducing an explosion hazard and reducing the preheating time of piercing.

### BRIEF DESCRIPTION OF THE DRAWINGS

FIG. 1 is a system diagram illustrating a gas cutting machine according to an embodiment of the invention.

FIG. 2 is an enlarged sectional view illustrating a cutting tip used in the gas cutting machine according to the embodiment of the invention.

FIG. 3 is a ternary diagram illustrating an explosive range of hydrogen in oxygen and an explosive range of propane in oxygen in fuel gas.

FIG. 4 is a sectional view schematically illustrating another example of the cutting tip used in the gas cutting apparatus according to the embodiment of the invention.

FIG. 5 is a diagram illustrating the relationship between a propane concentration in the fuel gas and a highest cutting speed in Verification Test 1 of the invention.

FIG. 6A is a diagram illustrating the relationship between the fuel gas and a flame core formed at an end of the cutting tip when 100% hydrogen gas is used as the fuel gas in Verification Test 2 of the invention.

FIG. 6B is a diagram illustrating the relationship between the fuel gas and the flame core formed at the end of the cutting tip when mixed gas of hydrogen gas and 1% propane gas is used as the fuel gas in Verification Test 2 of the invention.

FIG. 6C is a diagram illustrating the relationship between the fuel gas and the flame core formed at the end of the cutting tip when mixed gas of hydrogen gas and 3% methane gas is used as the fuel gas in Verification Test 2 of the invention.

FIG. 7A is a diagram illustrating the relationship between a flow channel in the cutting tip and a state of preheating gas when a tilt is formed in Verification Test 3 of the Invention.

FIG. 7B is a diagram illustrating the relationship between the flow channel in the cutting tip and the state of preheating gas when a tilt is not formed in Verification Test 3 of the Invention.

FIG. 8 is a diagram illustrating the measurement result of a piercing preheating time in Verification Test 3 of the invention.

FIG. 9 is a system diagram illustrating the configuration of a gas cutting machine according to the background art.

### BEST MODE FOR CARRYING OUT THE INVENTION

Hereinafter, a gas cutting method according to an embodiment of the invention along with a gas cutting machine and a cutting tip used in the gas cutting method will be described in detail with reference the accompanying drawings. In the drawings used for the description, for the purpose of easy understanding, important parts may be enlarged and the size ratios of elements may not be equal to the actual ones.

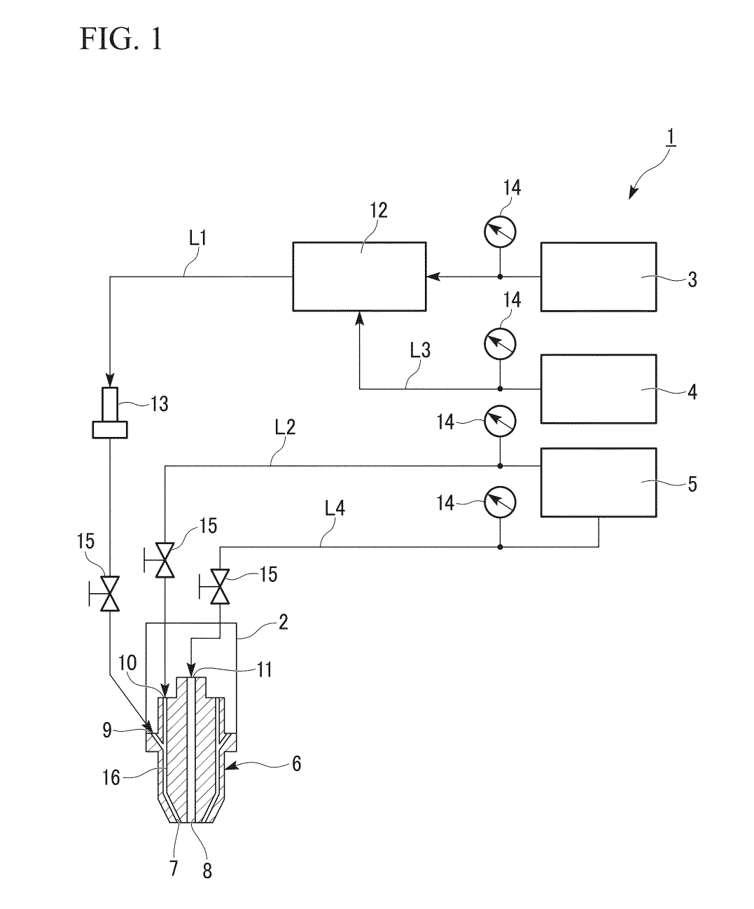

FIG. 1 is a system diagram illustrating a gas cutting machine used in a gas cutting method according to an embodiment of the invention. As shown in FIG. 1, the gas cutting machine 1 according to this embodiment roughly includes a cutting blowpipe 2 including a cutting tip 6 having a preheating hole 7 and a cutting oxygen hole 8 formed therein, a hydrogen gas supply source 3 supplying hydrogen gas, a hydrocarbon gas supply source 4 supplying hydrocarbon gas, an oxygen gas supply source 5 supplying preheating oxygen gas, a fuel gas pipeline L1 supplying fuel gas including hydrogen gas and hydrocarbon gas to the cutting tip 6, and a preheating oxygen gas pipeline L2 supplying preheating oxygen gas to the cutting tip 6.

The cutting blowpipe 2 is not particularly limited and a typical cutting blowpipe can be used.

The cutting tip 6 is disposed at an end of the cutting blowpipe 2. An end of the cutting tip 6 is provided with a preheating hole 7 used to form a preheating flame using fuel gas and preheating oxygen gas and a cutting oxygen hole 8 used to eject cutting oxygen gas to cut a workpiece. The base end of the cutting tip 6 is provided with a fuel gas flow channel 9, a preheating oxygen gas flow channel 10, and a cutting oxygen gas flow channel 11. The fuel gas flow channel 9 and the preheating oxygen gas flow channel 10 join inside the cutting tip 6.

An end of the fuel gas pipeline L1 is connected to the hydrogen gas supply source 3 and the other end thereof is connected to the fuel gas flow channel 9 of the cutting tip 6. A mixer 12 is disposed in the fuel gas pipeline L1 and the hydrocarbon gas supply source 4 is connected to the mixer 12 via a hydrocarbon gas pipeline L3. Accordingly, the mixer 12 is supplied with hydrogen gas from the hydrogen gas supply source 3 and is supplied with hydrocarbon gas from the hydrocarbon gas supply source 4, whereby mixed gas in which hydrocarbon gas of more than 0 vol % and equal to or less than 4 vol % is mixed into hydrogen gas is produced. The fuel gas pipeline L1 downstream from the mixer 12 is supplied with the mixed gas as the fuel gas.

Here, the fuel gas in this embodiment is the mixed gas in which hydrocarbon gas of more than 0 vol % and equal to or less than 4 vol % is mixed into hydrogen gas, as described later in the verification tests. A flame core is visible because a carbon component in the fuel gas emits white light by combustion and is not visible in the fuel gas of 100% hydrogen.

The concentration of hydrocarbon gas mixed into the fuel gas is set to be as low as possible, and is preferably set to the range of 0.2 to 4 vol %, from the viewpoint of visibility of a flame core.

When propane or the like containing a relatively large amount of carbon component is used, the concentration of hydrocarbon gas is preferably equal to or more than 0.4 vol % and more preferably equal to or more than 1 vol %. When methane or the like having a small amount of carbon component is used, the concentration of hydrocarbon gas is preferably equal to or more than 3 vol %. When butane or the like is used, the concentration of hydrocarbon gas is preferably equal to or more than 0.2 vol %.

When LP containing propane as a major component is used as the hydrocarbon gas, the concentration of propane in the mixed gas is preferably equal to or more than 0.4 vol % and more preferably equal to or more than 1 vol %.

When LNG containing methane as a major component is used, the concentration of methane in the mixed gas is preferably equal to or more than 3 vol %. When town gas containing butane as a major component is used, the concentration of butane in the mixed gas is preferably equal to or more than 0.2 vol %.

On the other hand, regarding the cutting speed, when the concentration of hydrocarbon gas in the hydrogen gas is more than 4 vol %, the cutting speed is rapidly lowered in comparison with the cutting speed when 100% hydrogen gas is used as the fuel gas and the merit of use of hydrogen gas as the fuel gas is very low, which is not preferable. On the contrary, when the mixing proportion of hydrocarbon gas in the hydrogen gas is equal to or less than 4 vol %, the cutting speed is not influenced, which is preferable.

A backfire arrester 13 and an on-off valve (as which a check valve is preferably used; the same is true of the following) 15 are disposed as safety measures in the fuel gas pipeline L1. A pressure meter 14 is disposed in each of the fuel gas pipeline L1 and the hydrocarbon gas pipeline L3.

An end of the preheating oxygen gas pipeline L2 is connected to the oxygen gas supply source 5 and the other end thereof is connected to the preheating oxygen gas flow channel 10 of the cutting tip 6. A pressure meter 14 and an on-off valve 15 are disposed in the preheating oxygen gas pipeline L2.

An end of the cutting oxygen gas pipeline L4 is connected to the oxygen gas supply source 5 and the other end thereof is connected to the cutting oxygen gas flow channel 11 of the cutting tip 6. A pressure meter 14 and an on-off valve 15 are disposed in the cutting oxygen gas pipeline L4.

In the gas cutting machine 1 according to this embodiment, the configuration in which the preheating oxygen gas pipeline L2 and the cutting oxygen gas pipeline L4 are connected to the same oxygen gas supply source 5 is exemplified, but the invention is not limited to this configuration. That is, the preheating oxygen gas pipeline L2 and the cutting oxygen gas pipeline L4 may be connected to different oxygen gas supply sources.

The hydrogen gas supply source 3 is not particularly limited, as long as it can supply simple hydrogen gas to the fuel gas pipeline L1 and the fuel gas flow channel 9 without being mixed with oxygen before hydrogen gas and preheating oxygen gas are mixed.

A bomb filled with hydrogen gas and widely used in general may be used as the hydrogen gas supply source 3, or gas produced from a water-splitting apparatus electrolyzing water to produce hydrogen and oxygen may be used. Here, when the gas from the water-splitting apparatus is used, it is necessary to select such a type of apparatus from which hydrogen and oxygen can be separately extracted without there being an explosion hazard due to mixture of hydrogen and oxygen.

The hydrocarbon gas supply source 4 is not particularly limited, and a bomb filled with hydrocarbon gas can be used.

The hydrocarbon gas in this embodiment is not particularly limited, and typical hydrocarbon gas such as LPG, LNG, town gas, ethylene, acetylene, methane, ethane, propane, and butane or mixed gas thereof can be used.

The oxygen gas supply source 5 is not particularly limited, as long as it can supply simple oxygen gas to the preheating oxygen gas pipeline L2 and the cutting oxygen gas pipeline L4 without being mixed with hydrogen before it mixes with the fuel gas.

A bomb filled with oxygen gas and widely used in general may be used as the oxygen gas supply source 5, or gas produced from a water-splitting apparatus electrolyzing water to produce hydrogen and oxygen may be used. Here, when the gas from the water-splitting apparatus is used, it is necessary to select such a type of apparatus from which hydrogen and oxygen can be separately extracted without there being an explosion hazard due to mixture of hydrogen and oxygen. Even in such a type involving separately extracting hydrogen and oxygen produced from the water-splitting apparatus, there is possibility of mixture of oxygen into hydrogen or of mixture of hydrogen into oxygen. The amounts to be mixed are preferably as small as possible, but there is no problem when the amounts are less than the lower explosion limit.

The oxygen gas supply source 5 may be separately disposed in the preheating oxygen gas pipeline L2 and the cutting oxygen gas pipeline L4.

The cutting tip 6 serves to form a preheating flame using the fuel gas and the preheating oxygen gas and to eject the cutting oxygen gas and is disposed at an end of the cutting blowpipe 2. The cutting tip 6 roughly includes a cutting oxygen gas flow channel 11 passing through the center in the axis direction, a preheating gas flow channel 16 as a flow channel of mixed gas of the fuel gas and the preheating oxygen gas that is disposed outside the cutting oxygen gas flow channel 11, a cutting oxygen hole 8 disposed at an end of the cutting oxygen gas flow channel 11, and a preheating hole 7 disposed at an end of the preheating gas flow channel 16.

Here, the cutting tip 6 according to this embodiment is of a tip mixing type of causing the fuel gas flow channel 9 and the preheating oxygen gas flow channel 10 to join each other inside the cutting tip 6 to constitute the preheating gas flow channel 16, as shown in FIG. 1. The fuel gas pipeline L1 is connected to the fuel gas flow channel 9 and the preheating oxygen gas pipeline L2 is connected to the preheating oxygen gas flow channel 10. Therefore, in the gas cutting machine 1 according to this embodiment, the fuel gas pipeline L1 and the preheating oxygen gas pipeline L2 join inside the cutting tip 6.

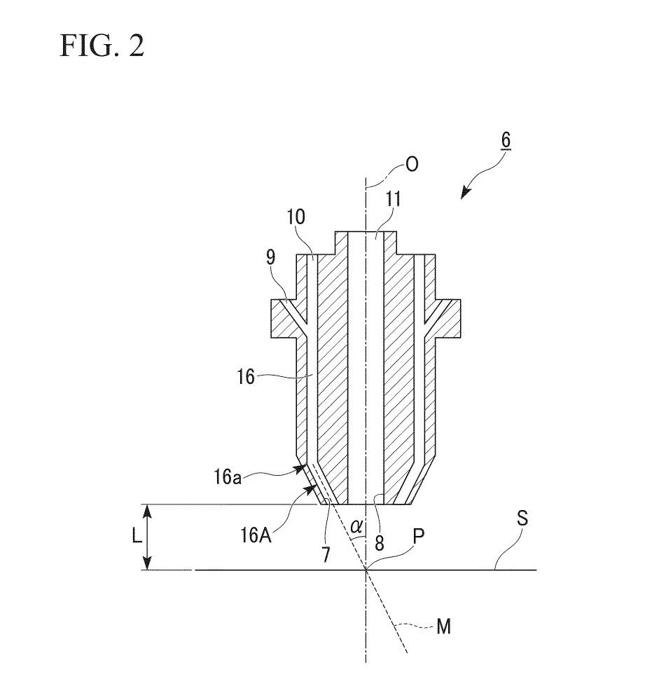

In the cutting tip 6 according to this embodiment, as shown in FIG. 2, a bent portion 16a is formed in the preheating gas flow channel 16 in the cutting tip 6. The part of the preheating gas flow channel 16 closer to the base end from the bent portion 16a is disposed to be parallel to the cutting oxygen gas flow channel 11 disposed along the center in the axis direction and the part 16A closer to the end from the bent portion 16a is tilted toward the cutting oxygen gas flow channel 11. Accordingly, the preheating gas ejected from the preheating hole 8 can be concentrated on the center in the axis direction of the cutting tip 6.

In this embodiment, the configuration in which the bent portion 16 is formed in the preheating gas flow channel 16 is exemplified, but the invention is not limited to this configuration. For example, the preheating gas flow channel 16 may have a configuration in which the flow channel part closer to the base end and parallel to the axis direction and the flow channel part closer to the end and tilted toward the cutting oxygen gas flow channel 11 are connected with a slowly-curved flow channel.

Here, the tilt angle (that is, an angle formed by a straight line M connecting the bent portion 16a of the preheating gas flow channel 16 to the preheating hole 8 and the cutting oxygen gas flow channel 11 disposed at in the center line O in the axis direction of the cutting tip 6) a of the part 16A of the preheating gas flow channel 16 closer to the end is preferably set to such an angle to most enhance the convergence of the preheating gas. Specifically, the tilt angle a is preferably set so that the junction (focal point) P at which the straight line M and the straight line O join is located on the surface S of a cutting material (workpiece), as shown in FIG. 2. The distance L from the surface S of the cutting material (workpiece) to the end of the cutting tip is typically set to be in the range of 10 to 20 mm.

A gas cutting method according to an embodiment of the invention using the gas cutting machine 1 will be described below.

Specifically, as shown in FIG. 1, various gas supply systems used in performing the gas cutting in this embodiment will be described.

First, hydrogen gas is supplied to the fuel gas pipeline L1 from the hydrogen gas supply source 3. The hydrogen gas is adjusted in pressure through the use of the pressure controller 14 and is then supplied to the mixer 12.

Similarly, hydrocarbon gas is supplied to the hydrocarbon gas pipeline L3 from the hydrocarbon gas supply source 4. The hydrocarbon gas is adjusted in pressure through the use of the pressure controller 14 and is then supplied to the mixer 12.

The mixer 12 mixes the hydrogen gas and the hydrocarbon gas so as to satisfy a preset mixing proportion (that is, equal to or more than 96 vol % of hydrogen gas and equal to or less than 4 vol % of hydrocarbon gas). Then, the mixed gas is supplied as the fuel gas to the fuel gas pipeline L1 from the mixer 12. The fuel gas is supplied to the fuel gas flow channel 9 of the cutting tip 6 via the backfire arrester 13 for hydrogen gas and the on-off valve 15.

Oxygen gas is supplied to the preheating oxygen gas pipeline L2 and the cutting oxygen gas pipeline L4 from the oxygen gas supply source 5. The oxygen gas supplied to the preheating oxygen gas pipeline L2 is supplied as the preheating oxygen gas to the preheating oxygen gas flow channel 10 of the cutting tip 6 via the pressure controller 14 and the on-off valve 15. The fuel gas and the preheating oxygen gas are mixed inside the cutting tip 6 and are ejected and ignited from the preheating hole 7 to form a preheating flame.

The oxygen gas supplied to the cutting oxygen gas pipeline L4 is supplied as the cutting oxygen gas to the cutting oxygen flow channel 11 of the cutting tip 6 via the pressure controller 14 and the on-off valve 15, is ejected from the cutting oxygen hole 8, and reacts with a steel sheet heated by the preheating flame to perform a cutting operation.

In the gas cutting method according to the background art, when 100% hydrogen gas is used as the fuel gas, the cutting speed can be raised further than that when 100% hydrocarbon gas is used as the fuel gas. However, since a flame core generated at the end of the cutting tip is not visible, there is a problem in that it is difficult to adjust the preheating flame.

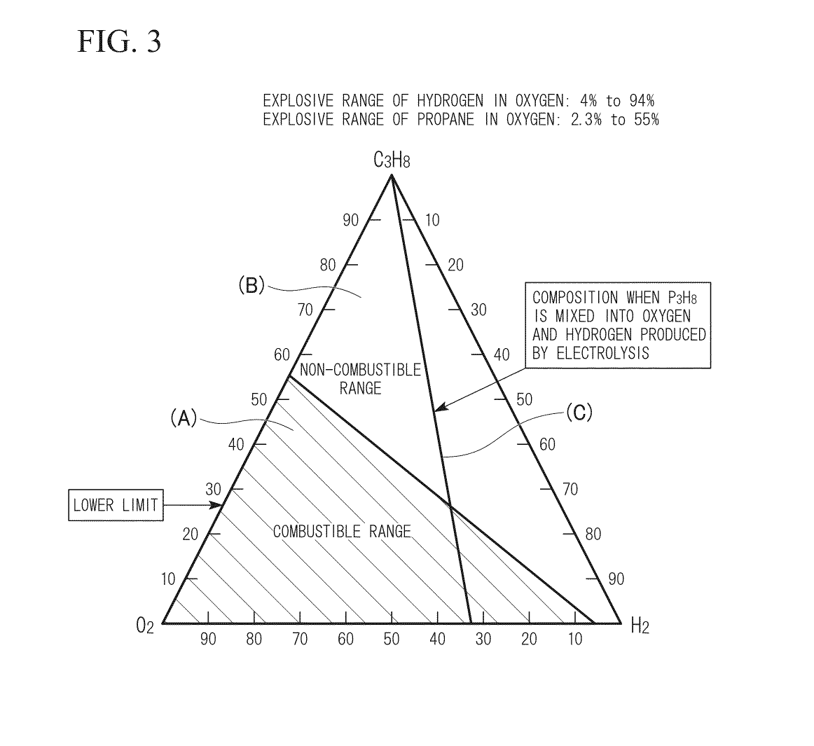

In the gas cutting method according to the background art, when the hydrocarbon gas is mixed into the mixed gas (oxyhydrogen gas) of oxygen gas and hydrogen gas as the fuel gas so as to reach the lower explosion limit, there is a problem in that it is possible to guarantee safety but the cutting speed is lowered. Here, the explosive range of hydrogen in oxygen and the explosive range of propane in oxygen are shown in FIG. 3. Area (A) in FIG. 3 indicates a combustible range and area (B) indicates a non-combustible range. Straight line (C) in the ternary diagram indicates the composition when propane is mixed into oxygen and hydrogen produced by electrolysis. As shown in FIG. 3, the hydrogen concentration less than the lower explosion limit in oxygen is equal to or less than 4% and the oxygen concentration less than the lower explosion limit in hydrogen is equal to or less than 6%.

On the contrary, in the gas cutting method according to this embodiment, since the mixed gas in which hydrocarbon gas of more than 0 vol % and equal to or less than 4 vol % is mixed into hydrogen gas is used as the fuel gas, it is possible to achieve both the speed equivalent to the cutting speed when hydrogen gas is used as the fuel gas and the visibility of a flame core generated at the end of the cutting tip due to combustion of the hydrocarbon gas.

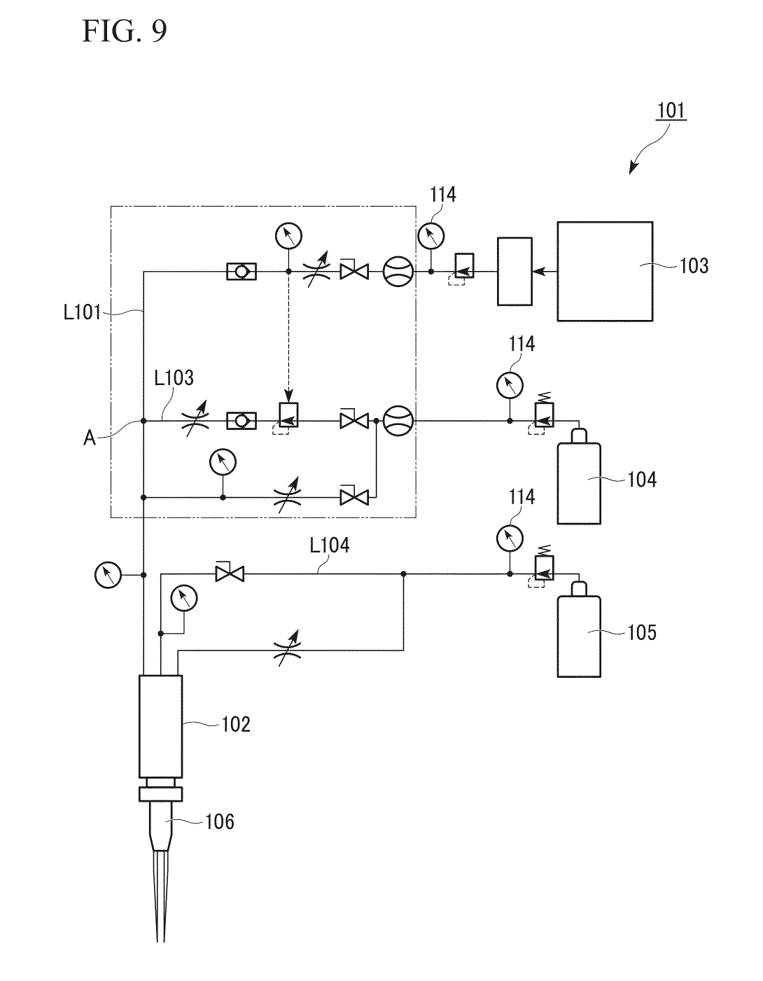

In the gas cutting machine 101 according to the background art shown in FIG. 9, mixed gas of the oxyhydrogen gas in which oxygen gas and hydrogen gas are mixed and the hydrocarbon gas with a concentration as the lower explosion limit is supplied as the fuel gas to the pipeline L101. Accordingly, when there is a problem with the supply of the fuel gas for some reasons to cause an explosion, there is the possibility of destruction of the entire upstream side of the pipeline L101 supplied with the oxyhydrogen gas.

On the contrary, in the gas cutting machine 1 according to this embodiment, the hydrogen gas supply source 3 supplying hydrogen gas, which is the major component of the fuel gas, as simple hydrogen gas and the fuel gas into which hydrocarbon gas is mixed and the preheating oxygen gas are made to mix inside the cutting tip 6.

Accordingly, when an explosion is caused between the fuel gas and the preheating oxygen gas, there is no possibility of explosion of the pipeline on the upstream side (the primary side) of the cutting tip 6. Accordingly, it is possible to use a fuel gas into which hydrocarbon gas is mixed to be equal to or lower than the lower explosion limit as shown in FIG. 2.

As described above, in the gas cutting method and the gas cutting machine 1 according to this embodiment, since the hydrogen gas as the major component of the fuel gas and the oxygen gas are not mixed before reaching the cutting blow pipe 2 or the cutting tip 6, it is possible to greatly reduce the explosion hazard in the fuel gas pipeline L1, thereby enhancing the safety thereof

Since the proportion of the hydrocarbon gas to be mixed into the hydrogen gas as the major component of the fuel gas is set to a low proportion of more than 0 vol % (the lowest proportion at which the flame core is visible) and equal to or less than 4 vol % (the highest proportion at which the cutting speed can be maintained), it is possible to guarantee the superior cutting performance inherent to the hydrogen gas and to allow the flame core to be visualized, thereby allowing the preheating flame to be easily adjusted.

By combining the cutting tip 6 in which the part 16A of the preheating gas flow channel 16 to the end is tilted toward the center of the cutting tip, it is possible to allow more convergent preheating. Accordingly, it is possible to suppress a backfire caused because the preheating gas flow channel 16 of the cutting tip is clogged with the blowup of molten metal which often occurs mainly in piercing (boring) processes, thereby reducing the explosion hazard and reducing the preheating time of piercing.

The technical scope of the invention is not limited to the above-mentioned embodiment, but various modifications may be added thereto without departing from the concept of the invention. For example, the gas cutting machine 1 according to the above-mentioned embodiment employs the configuration using the cutting tip 6 in which the fuel gas and the preheating oxygen gas mix inside the cutting tip, but the invention is not limited to this configuration.

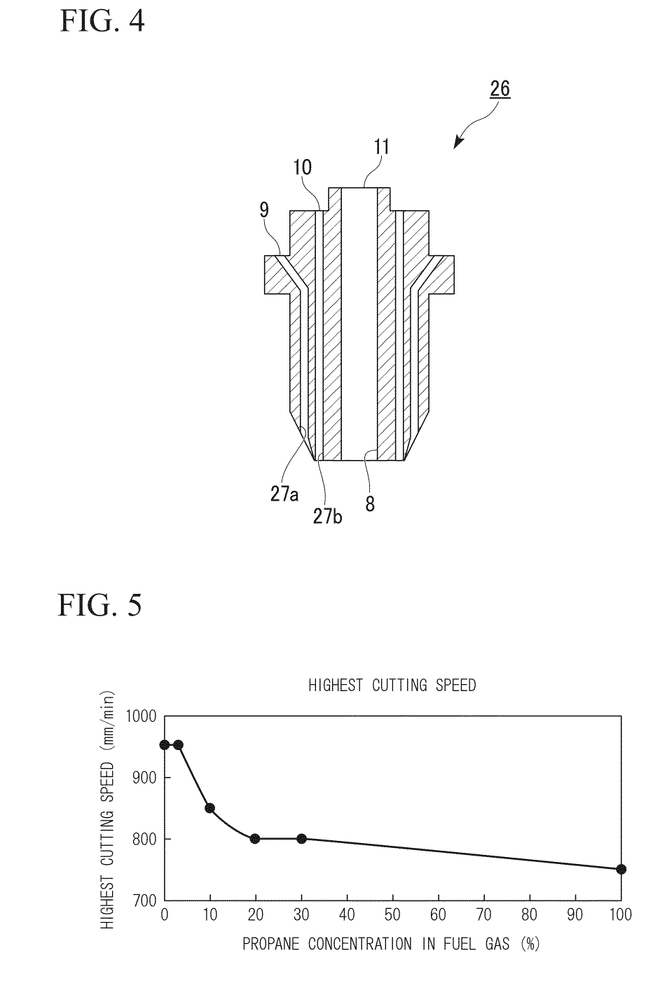

For example, as shown in FIG. 4, a cutting tip 26 of a post-mixing type in which the fuel gas flow channel 9 and the preheating oxygen gas flow channel 10 are independent of each other inside the cutting tip and are mixed outside the cutting tip (at an end of the cutting tip) after being ejected from the preheating holes 27a and 27b may be employed.

By employing this type of cutting tip 26, it is possible to achieve the same advantageous effects as described in the above-mentioned embodiment and it is also possible to further enhance the safety against the explosion due to the backfire.

Although not shown in the drawings, a gas cutting machine including a cutting blowpipe having a mixing room (also referred to as a mixer) therein may be employed so that the fuel gas and the preheating oxygen gas are mixed in the mixing room in the cutting blowpipe and are then supplied to the cutting tip.

Specific examples will be described below.

### Verification Test 1

In an example where propane is used as the hydrocarbon gas constituting the fuel gas, the influence on the cutting speed was evaluated when various concentrations of propane were mixed into hydrogen fuel gas. In the method of evaluating the influence on the cutting speed, a phenomenon that the cutting is stopped, which is referred to as cutting loose, occurs when the cutting speed is made to slowly increase under the same condition. The highest speed at which the cutting loose does not occur was recorded. The cutting conditions are shown in Table 1. FIG. 5 shows the relationship between the propane concentration in the fuel gas and the highest cutting speed.

TABLE 1

| | |
|---|---|
| Base metal | SS400 with thickness of 12 mm |
| | (cutting length of 200 mm) |
| Cutting tip | 3011#1 made by NISSAN TANAKA |
| | Corporation |
| Amount of combustion heat (MJ/h) | 25 |
| Mixing proportion of preheating | Neutral mixture |
| oxygen | |

As shown in Table 1, regarding the mixing proportion of preheating oxygen mixed into the fuel gas, there are typically a stoichiometric mixing proportion using chemical formulas and a neutral mixing proportion in which oxygen in air is considered, and the neutral mixture in which a preheating flame is stabilized was used in this verification.

As shown in FIG. 5, the highest cutting speed was 750 (mm/min) when the propane concentration in the fuel gas was 100%, and the highest cutting speed was 950 (mm/min) in the fuel gas in which 1 to 4 vol % of propane was mixed into hydrogen gas. It was confirmed from this result that the cutting speed was raised by about 27%.

The cutting speed was not influenced when the mixing proportion of propane in hydrogen gas was equal to or less than 4 vol %, and the cutting speed was rapidly lowered when the mixing proportion of propane was more than 4 vol %. When the propane concentration reached about 20 vol %, it was confirmed that there was no difference from the cutting speed when the propane concentration was 100% and thus the merit of use of hydrogen gas as the fuel gas was very small.

### Verification Test 2

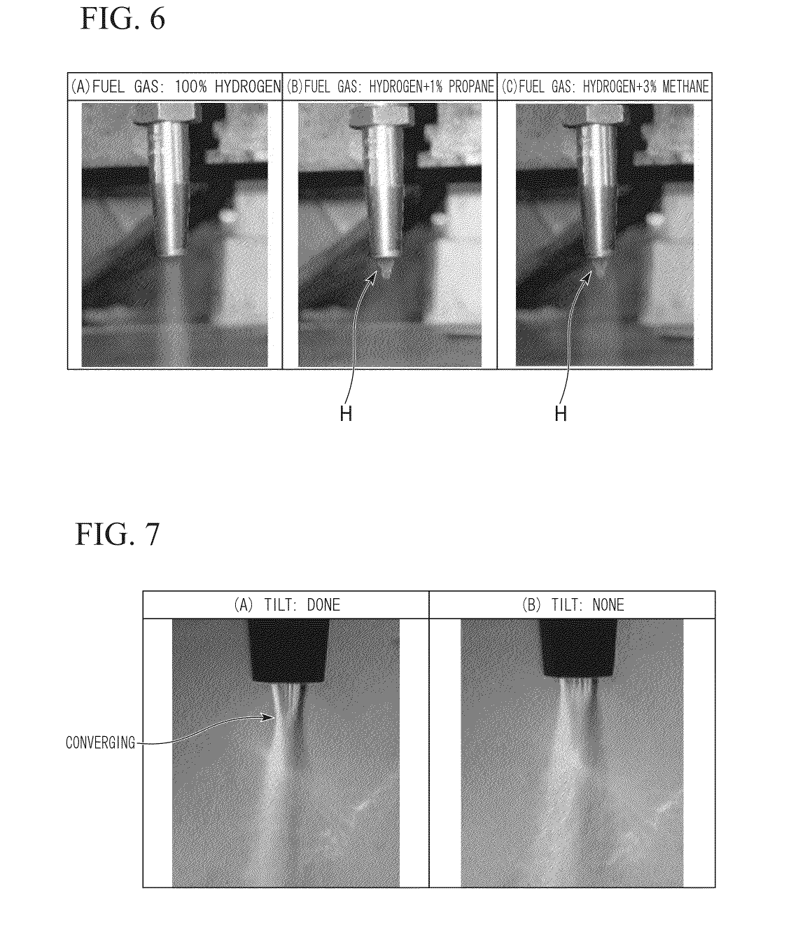

The visibility of a flame core generated at the end of the cutting tip with respect to a variety of fuel gases was evaluated. FIGS. 6A, 6B, and 6C show photographs of flame cores generated at the end of the cutting tip with respect to a variety of fuel gases. The flame core was visible because the carbon component in the fuel gas emits white light by combustion. Accordingly, as shown in FIG. 6A, when 100% hydrogen was used as the fuel gas, it was confirmed that no flame core was visible.

On the contrary, as shown in FIG. 6B, when mixed gas in which 1 vol % of propane was mixed into hydrogen gas was used as the fuel gas, the flame core (region H in the drawing) was satisfactorily visible. When the propane concentration was reduced, the flame core was visible up to 0.4 vol %.

As shown in FIG. 6C, when methane containing the smallest amount of carbon component was mixed, it was confirmed that the flame core (region H in the drawing) was visible at the mixing proportion of 3 vol %.

When butane was mixed, it was confirmed that a flame core was visible at the mixing proportion of 0.2 vol %.

It was confirmed from the verification results that the flame core generated at the end of the cutting tip was visible by forming the fuel gas with a mixing proportion of equal to or less than 3 vol % with respect to hydrogen gas even when any hydrocarbon gas was selected.

### Verification Test 3

When a cutting tip in which the preheating gas flow channel in the cutting tip is tilted toward the center of the cutting tip and a cutting tip in which the preheating gas flow channel in the cutting tip is parallel to the cutting oxygen gas flow channel were used, influences on the convergence of the preheating gas toward the center of the cutting tip and the preheating time for piecing were evaluated.

FIGS. 7A and 7B are photographs illustrating a state where the preheating gas flows and are photographed by the use of the Schlieren instrument that can visualize a flow of gas. The photographing conditions of the Schlieren instrument are shown in Table 2.

TABLE 2

| | |
|---|---|
| Cutting tip | 3011#1 made by NISSAN TANAKA Corporation |
| | (tilt: done) |
| | 3051#1 made by NISSAN TANAKA Corporation |
| | (tilt: none) |
| Flow rate of gas | 10 L/min |
| Fluid | CO₂ |

In FIG. 7A in which the preheating gas flow channel is tilted, it was confirmed that the preheating gas was narrowed toward the center of the cutting tip after being ejected from the end of the cutting tip, compared with FIG. 7B in which the preheating gas flow channel is not tilted.

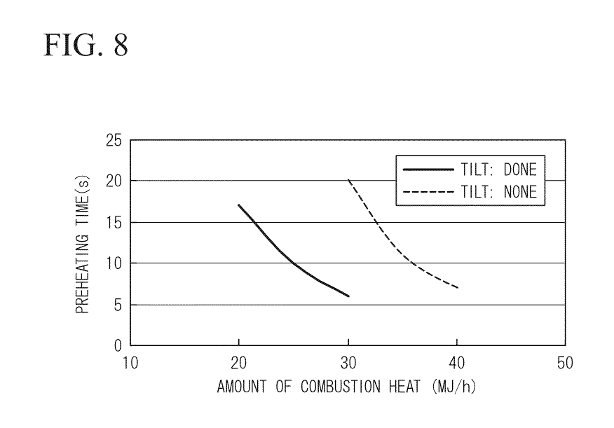

The measurement conditions obtained by measuring the preheating time for piercing using the cutting tips which differ in convergence are shown in Table 3 and the measurement results thereof are shown in FIG. 8.

TABLE 3

| | |
|---|---|
| Base metal | SS400 with thickness of 25 mm |
| Cutting tip | 3011#1 made by NISSAN TANAKA |
| | Corporation (tilt: done) |
| | 3051#1 made by NISSAN TANAKA |
| | Corporation (tilt: none) |
| Amount of combustion heat (MJ/h) | 20~40 |
| Fuel gas | 99% H₂ + 1% propane |
| Mixing proportion of preheating | Neutral mixture |
| oxygen | |

As shown in FIG. 8, the cutting tip in which a tilt is formed in the preheating gas flow channel finishes the preheating with a smaller amount of combustion heat for a shorter time, compared with the cutting tip in which the tilt is not formed.

### INDUSTRIAL APPLICABILITY

The gas cutting method according to the invention can be applied to cutting a workpiece by the use of a cutting tip including a preheating hole for forming a preheating flame using fuel gas and preheating oxygen gas and a cutting oxygen hole for ejecting cutting oxygen gas to cut a workpiece.

### EXPLANATION OF REFERENCES

1: GAS CUTTING MACHINE
2: CUTTING BLOWPIPE
3: HYDROGEN GAS SUPPLY SOURCE
4: HYDROCARBON GAS SUPPLY SOURCE
5: OXYGEN GAS SUPPLY SOURCE
6: CUTTING TIP
7: PREHEATING HOLE
8: CUTTING OXYGEN HOLE
9: FUEL GAS FLOW CHANNEL
10: PREHEATING OXYGEN GAS FLOW CHANNEL
11: CUTTING OXYGEN GAS FLOW CHANNEL
12: MIXER
13: BACKFIRE ARRESTER
14: PRESSURE METER
15: ON-OFF VALVE (CHECK VALVE)
16: PREHEATING GAS FLOW CHANNEL
16a: BENT PORTION
16A: END PORTION (END)
α: TILT ANGLE
L1: FUEL GAS PIPELINE
L2: PREHEATING OXYGEN GAS PIPELINE
L3: HYDROCARBON GAS PIPELINE
L4: CUTTING OXYGEN GAS PIPELINE

1. A gas cutting method comprising:
mixing hydrogen gas and hydrocarbon gas to acquire fuel gas;
ejecting a preheating flame, which is formed by mixing and igniting the fuel gas and preheating oxygen gas, from an end of a cutting tip to heat a workpiece; and
ejecting cutting hydrogen gas to the heated workpiece to cut the workpiece,
wherein the content of the hydrocarbon gas in the fuel gas is more than 0 vol % and equal to or less than 4 vol %.

2. The gas cutting method according to claim 1, wherein the hydrocarbon gas is propane, and
wherein the content of propane in the fuel gas is equal to or more than 0.4 vol % and equal to or less than 4 vol %.

3. The gas cutting method according to claim 1, wherein the hydrocarbon gas is methane, and
wherein the content of methane in the fuel gas is equal to or more than 3 vol % and equal to or less than 4 vol %.

4. The gas cutting method according to claim 1, wherein the hydrocarbon gas is butane, and
wherein the content of butane in the fuel gas is equal to or more than 0.2 vol % and equal to or less than 4 vol %.

5. The gas cutting method according to claim 1, wherein the fuel gas and the preheating oxygen gas are mixed inside a cutting blowpipe, inside the cutting tip, or at an end of the cutting tip.

6. The gas cutting method according to claim 1, wherein when the preheating flame is ejected from an end of the cutting tip to the workpiece, the preheating flame is tilted toward the center in the axis direction of the cutting tip.

7. The gas cutting method according to claim 1, wherein the hydrogen gas and the preheating oxygen gas are supplied from a water-splitting apparatus, and
wherein an oxygen component in the hydrogen gas supplied from the water-splitting apparatus and a hydrogen component in the preheating oxygen gas supplied from the water-splitting apparatus are less than a lower explosion limit.

8. A gas cutting machine comprising:
a mixer that mixes hydrogen gas and hydrocarbon gas to acquire fuel gas;
a cutting tip that includes a preheating hole used to form a preheating flame using the fuel gas and preheating oxygen gas and a cutting oxygen hole used to eject cutting oxygen gas to cut a workpiece;
a cutting blowpipe that has the cutting tip disposed at an end thereof;
a fuel gas pipeline that supplies the fuel gas to the cutting blowpipe or the cutting tip;
a preheating oxygen gas pipeline that supplies the preheating oxygen gas to the cutting blowpipe or the cutting tip;
a hydrogen gas supply source that supplies the hydrogen gas to the mixer;
a hydrocarbon gas supply source that supplies the hydrocarbon gas to the pipeline; and
an oxygen gas supply source that supplies the preheating oxygen gas to the preheating oxygen gas pipeline,
wherein the content of the hydrocarbon gas in the fuel gas is more than 0 vol % and equal to or less than 4 vol %, and
wherein the fuel gas pipeline and the preheating oxygen gas pipeline join inside the cutting blowpipe, inside the cutting tip, or outside the cutting tip.

9. A cutting tip of a gas cutting machine, comprising:
a cutting oxygen gas flow channel that passes through the center in the axis direction of the cutting tip;
a preheating gas flow channel that is formed by joining a fuel gas flow channel and a preheating oxygen gas flow channel and that is disposed outside the cutting oxygen gas flow channel;
a cutting oxygen hole that is disposed at an end of the cutting oxygen gas flow channel; and
a preheating hole that is disposed at an end of the preheating gas flow channel,
wherein the end of the preheating gas flow channel is tilted to an extension of the cutting oxygen gas flow channel.

10. The cutting tip according to claim 9, wherein the distance from a junction of an extension from an end of the preheating gas flow channel and an extension of the cutting oxygen gas flow channel to the end of the cutting tip is in the range of 10 to 20 mm.

11. A cutting tip of a gas cutting machine, comprising:
a cutting oxygen gas flow channel that passes through the center in the axis direction of the cutting tip;
a fuel gas flow channel that is disposed outside the cutting oxygen gas flow channel;
a preheating oxygen gas flow channel that is disposed outside the cutting oxygen gas flow channel;
a cutting oxygen hole that is disposed at an end of the cutting oxygen gas flow channel;
a preheating hole that is disposed at an end of the fuel gas flow channel; and
a preheating hole that is disposed at an end of the preheating oxygen gas flow channel,
wherein the fuel gas flow channel and the preheating oxygen gas flow channel are independent of each other in the cutting tip, and
wherein the end of the fuel gas flow channel and the end of the preheating oxygen gas flow channel are tilted to an extension of the cutting oxygen gas flow channel.
